(19) United States
(12) Patent Application Publication
(10) Pub. No.: US 2022/0027797 A1
(43) Pub. Date: Jan. 27, 2022

(54) HYBRID DATA CHUNK CONTINUOUS MACHINE LEARNING

(71) Applicant: International Business Machines Corporation, Armonk, NY (US)

(72) Inventors: LEI TIAN, Xi'an (CN); Si Er Han, Xi'an (CN); Dong Hai Yu, Xian (CN); Liang Wang, Xi'an (CN); YI SHAO, XIAN (CN); Chun Lei Xu, XIAN (CN)

(21) Appl. No.: 16/936,518

(22) Filed: Jul. 23, 2020

(51) Int. Cl. G06N 20/20; G06N 5/04

(52) U.S. Cl. CPC G06N 20/20; G06N 5/04

(57) ABSTRACT

In an approach to mitigating model drift, one or more computer processors create an ensemble model set (EMS) comprising one or more component models, wherein each component model in the EMS is trained utilizing at least one of the following: a distinct algorithm, technique, and hybrid data chunk; calculate a set of weights for each component model in the EMS; responsive to detecting model drift, create a new component model based on a new hybrid data chunk and adding the new component model to the EMS; recalculate the set of weights for each component model in the EMS utilizing one or more evaluation techniques compared against the new hybrid data chunk; predict a final prediction by aggregating one or more predictions from one or more component models in a set of selected top component models between subsequent model drifts.

### BACKGROUND

The present invention relates generally to the field of machine learning, and more particularly to mitigating model drift.

Machine learning (ML) is the scientific study of algorithms and statistical models that computer systems use to perform a specific task without using explicit instructions, relying on patterns and inference instead. Machine learning is seen as a subset of artificial intelligence. Machine learning algorithms build a mathematical model based on sample data, known as training data, in order to make predictions or decisions without being explicitly programmed to perform the task. Machine learning algorithms are used in a wide variety of applications, such as email filtering and computer vision, where it is difficult or infeasible to develop a conventional algorithm for effectively performing the task.

Ensemble modeling is a process where a plurality of multiple diverse models is created and trained to predict an outcome. Ensemble modeling utilizes different modeling algorithms and/or using different training sets then aggregates the prediction of each included model resulting in a final prediction for new data. Ensemble model drift occurs when the statistical properties of a target variable, which the model is trying to predict, change over time in unforeseen ways causing predictions to become less accurate.

### SUMMARY

Embodiments of the present invention disclose a computer-implemented method, a computer program product, and a system for mitigating model drift. The computer-implemented method includes one or more computer processers creating an ensemble model set (EMS) comprising one or more component models, wherein each component model in the EMS is trained utilizing at least one of the following: a distinct algorithm, technique, and hybrid data chunk. The one or more computer processors calculate a set of weights for each component model in the EMS, wherein each set of weights comprises a current model weight (CMW) and an accumulated model weight (AMW). The one or more computer processors responsive to detecting model drift, create a new component model based on a new hybrid data chunk and adding the new component model to the EMS. The one or more computer processors recalculate the set of weights for each component model in the EMS utilizing one or more evaluation techniques compared against the new hybrid data chunk. The one or more computer processors predict a final prediction by aggregating one or more predictions from one or more component models in a set of selected top component models between subsequent model drifts, wherein the predictions from each component model in the set of selected top component models associated with higher weights are given greater deference when aggregating the predictions.

### BRIEF DESCRIPTION OF THE DRAWINGS

FIG. 1 is a functional block diagram illustrating a computational environment, in accordance with an embodiment of the present invention;

FIG. 2 is a flowchart depicting operational steps of a program, on a server computer within the computational environment of FIG. 1, for mitigating model drift, in accordance with an embodiment of the present invention;

FIG. 3 illustrates operational steps of a program partitioning a plurality of data chunks and creating an EMS within the computational environment of FIG. 1, in accordance with an embodiment of the present invention;

FIG. 4 is a functional block diagram illustrating the EMS in the computational environment of FIG. 1, in accordance with an embodiment of the present invention; and

FIG. 5 is a block diagram of components of the server computer, in accordance with an embodiment of the present invention.

### DETAILED DESCRIPTION

Machine learning models are susceptible to model drift, where existing models become increasingly ineffective (i.e., model accuracy reductions) due to data changes over time as new data is incorporated. Traditional models deploy a model and retrain once new data deviates significantly from data contained in the original training set, although measuring drift and deviation is a complex and expensive task for many problem domains. For example, a financial forecasting model that predicts next quarterly revenue cannot retrain until the quarter passes and actual revenue is observed and transformed into associated labels. Models that do not incorporate new data become outdated and fail to generalize future data, decreasing the overall effectiveness of said models. Currently, new models are created and retrained with new data, replacing an existing model but frequently this technique leads to information loss as the existing model may contain useful information that is lost when said model is replaced. Another flawed traditional technique occurs when a new model is retrained with both existing data and new data, but the new data contains no new information thus increasing training time due to the training data set becoming larger. Here, the retrained model is not as accurate as the previous existing model and requires significantly more computational requirements due to the increased training sets. Traditionally, as new data continues to be incorporated into new retrained models, said models degrade (i.e., drift) due to the removal of relevant data in previous models, affecting the performance of the ensemble.

Embodiments of the present invention mitigate model drift, associated performance loss, and increased computational requirements by dynamically training, weighting, reordering, adding, and removing one or more component models based on historical and new data chunks. Embodiments of the present invention manage model deployment as a continuous process rather than a singular event. Embodiments of the present invention recognize that computational requirements of associated model sets and components model are reduced by controlling the inclusion of historical and new component models into a EMS based on one or more calculated weights (i.e., current model weight (CMW) and accumulated model weight (AMW)). Embodiments of the present invention construct an initial ensemble model set (EMS) utilizing existing data based on hybrid data chunk partitions. Embodiments of the present invention utilizes the calculated weights to dynamically reorganize (i.e., add models, remove models, and rank models) the EMS. Embodiments of the present invention collect new data (i.e., data chunks) when model drift is detected based on the initial EMS. Embodiments of the present invention update a plurality of weights based on an evaluation of the new data chunk.

Certain embodiments of the presentation utilize the managed (e.g., initial, and continuously refreshed EMS) to aggregate a plurality of weather predictions based on an EMS containing component models trained with continuously created hybrid data chunks. In this embodiment, the EMS is initially created with a plurality of component models each trained with one or more created hybrid chunk data containing structured or unstructured weather data (e.g., temperature, pressure, humidity, etc.). In this embodiment, the EMS is continuously monitored for model drift and once model drift is detected, the EMS is refreshed with new weather chunk data. In this embodiment, the component models within the EMS are refreshed and reordered based on one or more evaluations compared against the new weather chunk data. In this embodiment, the weather predictions of the top models in the EMS are aggregated based on associated weights and utilized for a final weather prediction based on new incoming weather data chunks. In this embodiment, EMS is continuously monitored and refreshed with new models and data as subsequent model drifts are detected. Implementation of embodiments of the invention may take a variety of forms, and exemplary implementation details are discussed subsequently with reference to the Figures.

The present invention will now be described in detail with reference to the Figures.

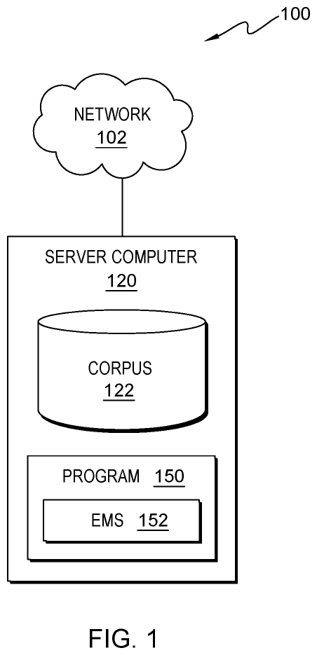

FIG. 1 is a functional block diagram illustrating a computational environment, generally designated 100, in accordance with one embodiment of the present invention. The term “computational” as used in this specification describes a computer system that includes multiple, physically, distinct devices that operate together as a single computer system. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Computational environment 100 includes server computer 120 connected over network 102. Network 102 can be, for example, a telecommunications network, a local area network (LAN), a wide area network (WAN), such as the Internet, or a combination of the three, and can include wired, wireless, or fiber optic connections. Network 102 can include one or more wired and/or wireless networks that are capable of receiving and transmitting data, voice, and/or video signals, including multimedia signals that include voice, data, and video information. In general, network 102 can be any combination of connections and protocols that will support communications between server computer 120, and other computing devices (not shown) within computational environment 100. In various embodiments, network 102 operates locally via wired, wireless, or optical connections and can be any combination of connections and protocols (e.g., personal area network (PAN), near field communication (NFC), laser, infrared, ultrasonic, etc.).

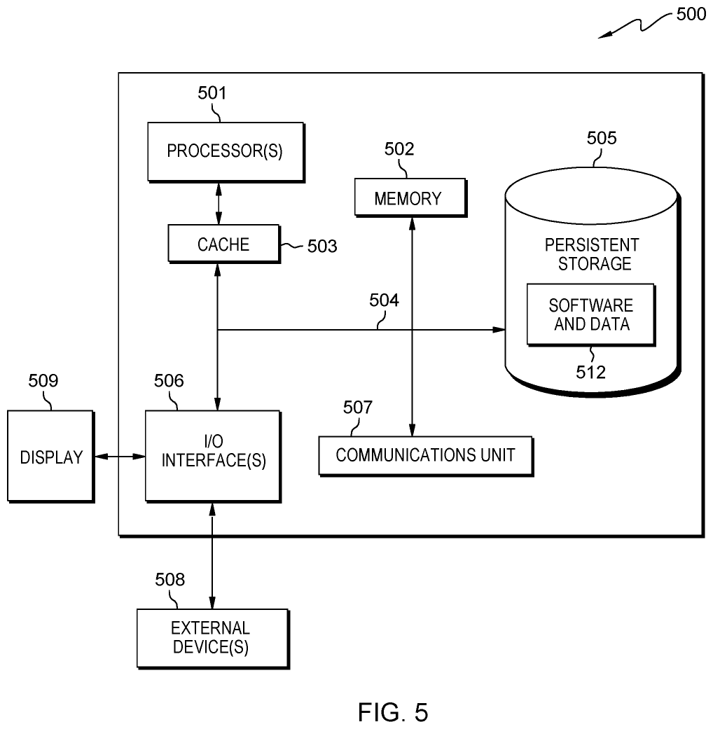

Server computer 120 can be a standalone computing device, a management server, a web server, a mobile computing device, or any other electronic device or computing system capable of receiving, sending, and processing data. In other embodiments, server computer 120 can represent a server computing system utilizing multiple computers as a server system, such as in a cloud computing environment. In another embodiment, server computer 120 can be a laptop computer, a tablet computer, a netbook computer, a personal computer (PC), a desktop computer, a personal digital assistant (PDA), a smart phone, or any programmable electronic device capable of communicating with other computing devices (not shown) within computational environment 100 via network 102. In another embodiment, server computer 120 represents a computing system utilizing clustered computers and components (e.g., database server computers, application server computers, etc.) that act as a single pool of seamless resources when accessed within computational environment 100. In the depicted embodiment, server computer 120 includes corpus 122 and program 150. In other embodiments, server computer 120 may contain other applications, databases, programs, etc. which have not been depicted in computational environment 100. Server computer 120 may include internal and external hardware components, as depicted and described in further detail with respect to FIG. 5.

Corpus 122 is a repository for data used by program 150. In the depicted embodiment, corpus 122 resides on server computer 120. In another embodiment, corpus 122 may reside elsewhere within computational environment 100 provided program 150 has access to corpus 122 where corpus 122 is an organized collection of data. Corpus 122 can be implemented with any type of storage device capable of storing data and configuration files that can be accessed and utilized by program 150, such as a database server, a hard disk drive, or a flash memory. In an embodiment, corpus 122 stores data used by program 150, such as a plurality of unstructured and structured data chunks contained in a training set (i.e., dataset) and/or plurality of training subsets and/or partitions. The chunking and partitioning process is further described in step 202.

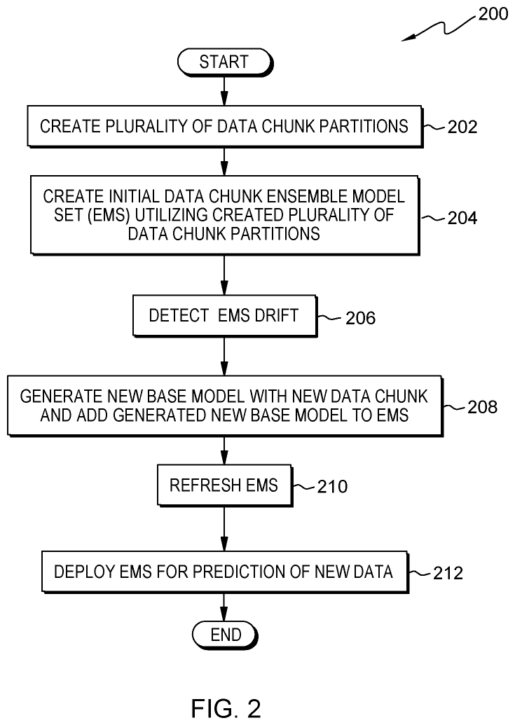

EMS 152 is representative of a plurality of component models, where each component model utilizes a different machine learning technique, model type, algorithm, and/or training set. In an embodiment, EMS 152 contains a list of N component models, where each contained component model (M1) has one or more associated weights, where larger weights denote a larger influence on a final ensemble prediction score. In an embodiment, EMS 152 is comprised of any combination of deep learning model, technique, and algorithm (e.g., decision trees, Naive Bayes classification, support vector machines for classification problems, random forest for classification and regression, linear regression, least squares regression, logistic regression). In an embodiment, EMS 152 is comprised of transferrable neural networks algorithms and models (e.g., long short-term memory (LSTM), deep stacking network (DSN), deep belief network (DBN), convolutional neural networks (CNN), compound hierarchical deep models, etc.) that can be trained with supervised or unsupervised methods. Program 150 utilizes EMS 152 to reduce the generalization error of a prediction. In an embodiment, the component models comprised in EMS 152 are diverse and independent models that limit model prediction error. In an embodiment, program 150 utilizes a plurality of component models as a single model (i.e., EMS 152). The training of EMS 152 and associated component models is depicted and described in further detail with respect to FIG. 2.

Program 150 is a program for mitigating model drift based on data chunk model ensembles. In various embodiments, program 150 may implement the following steps: creating an ensemble model set (EMS) comprising one or more component models, wherein each component model in the EMS is trained utilizing at least one of the following: a distinct algorithm, technique, and hybrid data chunk; calculating a set of weights for each component model in the EMS, wherein each set of weights comprises a current model weight (CMW) and an accumulated model weight (AMW); responsive to detecting model drift, creating a new component model based on a new hybrid data chunk and adding the new component model to the EMS; recalculating the set of weights for each component model in the EMS utilizing one or more evaluation techniques compared against the new hybrid data chunk; and predicting a final prediction by aggregating one or more predictions from one or more component models in a set of selected top component models between subsequent model drifts, wherein the predictions from each component model in the set of selected top component models associated with higher weights are given greater deference when aggregating the predictions. In the depicted embodiment, program 150 is a standalone software program. In another embodiment, the functionality of program 150, or any combination programs thereof, may be integrated into a single software program. In some embodiments, program 150 may be located on separate computing devices (not depicted) but can still communicate over network 102. In various embodiments, client versions of program 150 resides on any other computing device (not depicted) within computational environment 100. Program 150 is depicted and described in further detail with respect to FIG. 2.

The present invention may contain various accessible data sources, such as corpus 122, that may include personal storage devices, data, content, or information the user wishes not to be processed. Processing refers to any, automated or unautomated, operation or set of operations such as collection, recording, organization, structuring, storage, adaptation, alteration, retrieval, consultation, use, disclosure by transmission, dissemination, or otherwise making available, combination, restriction, erasure, or destruction performed on personal data. Program 150 provides informed consent, with notice of the collection of personal data, allowing the user to opt in or opt out of processing personal data. Consent can take several forms. Opt-in consent can impose on the user to take an affirmative action before the personal data is processed. Alternatively, opt-out consent can impose on the user to take an affirmative action to prevent the processing of personal data before the data is processed. Program 150 enables the authorized and secure processing of user information, such as tracking information, as well as personal data, such as personally identifying information or sensitive personal information. Program 150 provides information regarding the personal data and the nature (e.g., type, scope, purpose, duration, etc.) of the processing. Program 150 provides the user with copies of stored personal data. Program 150 allows the correction or completion of incorrect or incomplete personal data. Program 150 allows the immediate deletion of personal data.

FIG. 2 is a flowchart depicting operational steps of program 150 for mitigating model drift based on data chunk model ensembles, in accordance with an embodiment of the present invention.

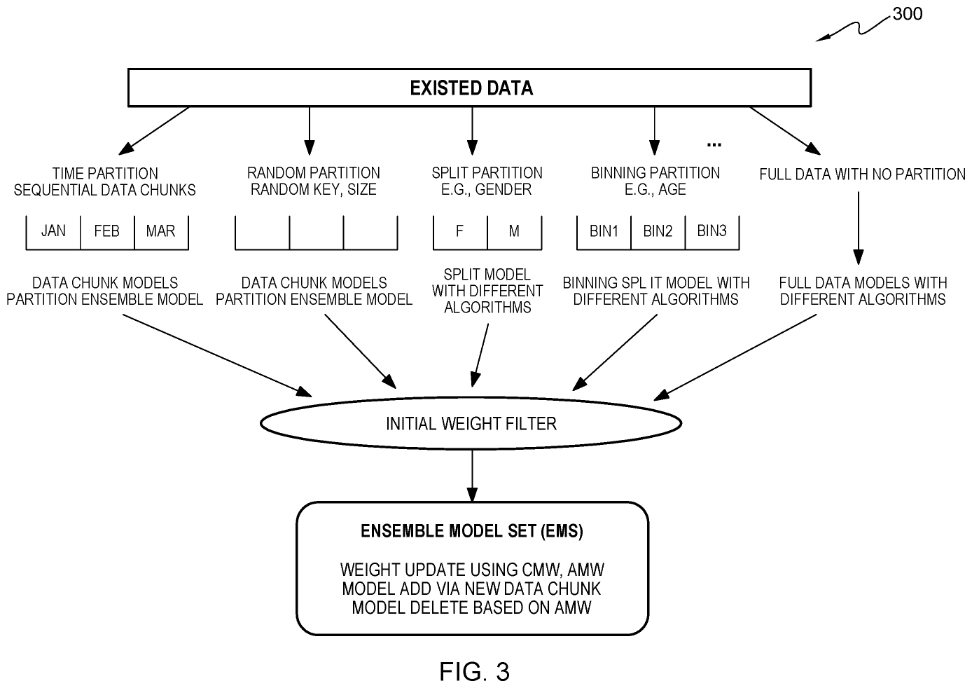

Program 150 creates a plurality of data chunk partitions (step 202). In an embodiment, program 150 initiates when detecting or receiving a plurality of data chunks. In various embodiments, program 150 retrieves chunk data or a plurality of partitions from corpus 122. In another embodiment, program 150 retrieves training data or one or more training sets from a plurality of sources, such as a publicly available external source, and stores said information within corpus 122. Responsively, program 150 utilizes a plurality of separation, partition, and/or chunking techniques, procedures, and methods to derive a plurality of training sets, subsets, hybrid data chunks, and/or partitions. In an embodiment, said hybrid data chunks ensures rich initial component models. In an embodiment, program 150 partitions a plurality of sequential data chunks utilizing associated time granularity (e.g., temporal qualifications) parameters and features (e.g., year, season, month, week, etc.). In another embodiment, program 150 partitions a plurality of random data chunks utilizing random keys and pre-configured set sizes. In another embodiment, program 150 partitions a plurality of data chunks utilizing categorical feature splitting, such as geographical splitting. In another embodiment, program 150 bins data chunks utilizing continuous feature binning to turn continuous variables into categorical values by grouping said values into a pre-defined number of bins. In another embodiment, program 150 utilizes the entire non-partitioned training set. In another embodiment, program 150 processes the non-partitioned training set into multiple distinct non-partitioned training sets utilizing a plurality of methods such as section filtering, sentence splitting, sentence tokenizer, part of speech (POS) tagging, tf-idf, etc. In a further embodiment, program 150 vectorizes (i.e., one-hot encoding, word embedded, dimension reduced, etc.) one or more hybrid data chunks. In various embodiments, program 150 utilizes associated domain and industry specific knowledge to define suitable partitions. In another embodiment, program 150 utilizes hyperparameter optimization (HPO) techniques to select suitable partitions with known evaluation strategies. FIG. 3 depicts the partitioning process described above.

Program 150 creates an initial data chunk ensemble model set (EMS) (step 204). Program 150 creates an ensemble model set (EMS) comprising one or more component models. In an embodiment, program 150 creates an EMS containing N component models, where each contained component model (Mᵢ) is trained utilizing a distinct algorithm, technique, and/or data chunk partition (Dᵢ). Program 150 trains each component model in EMS 152 with a corresponding data chunk partition (i.e., set). For example, a specific data chunk partition D₁, wherein data chunks are partitioned by time, for component model M₁ created and trained with D₁. In another example, program 150 retrieves a training dataset that includes only one partition used as a single data chunk, where the EMS contains only one component model.

Responsive to the initial creation of the EMS, program 150 calculates and assigns a set of weights for each component model contained in the EMS, where the set of weights comprise a current model weight (CMW) and an accumulated model weight (AMW). In an embodiment, program 150 computes an initial CMW for each component model utilizing one or more model assessments, evaluation measures, and metrics such as k-fold cross validation, mean bias error, modified Nash-Sutcliffe efficiency, root mean square error, and/or correlation coefficient. In another embodiment, program 150 logs and incorporates model statistics such as system memory utilization, central processing unit (CPU) utilization, graphics processing unit (GPU) utilization, hard drive utilization, and total training duration, into one or more associated weights. In an embodiment, program 150 assigns an initial AMW utilizing the calculated CMW value. In an embodiment, larger weights denote a larger influence on a final ensemble prediction score. In an example, program 150 utilizes cross validation as the evaluation measure to set an initial weight set associated with a model trained with one or more split (e.g., binning) partitions or a full dataset (i.e., no partitions). In an embodiment, program 150 tunes one or more models related to specific data chunk partitions. For example, program 150 utilizes gradient boosting for example data chunk partition D₁ and random forest for example data chunk partition D₂. In various embodiments, program 150 normalizes the initial weight set. In another embodiment, for each data chunk, program 150 generates a component model utilizing auto machine learning model selection, where the model type is different among different data chunks. For example, the component models associated with each data chunk are individual ensemble model sets (EMSs). Responsively, program 150 orders (i.e., ranks) the component models in terms of decreasing weight such that the weight of Mᵢ is greater than or equal to the weight of Mᵢ₊₁ for all component models.

Program 150 detects EMS drift (step 206). Responsive to the creation of the EMS, program 150 continuously monitors for model drift (i.e., EMS drift) by monitoring model performance and accuracy of the comprised component models and the performance (e.g., training times and computational requirements) and accuracy (e.g., prediction error rates, etc.) of the EMS as a whole. In an embodiment, program 150 monitors corresponding datasets, partitions, and data chunks for deviations or changes (e.g., addition or removal) in labels and/or data distribution (e.g., value ranges, calculated value histograms, training set sizes, etc.). In another embodiment, program 150 receives a notification or alert of model drift transmitted by a user. If program 150 does not detect an EMS drift, then program 150 moves to step 212 and deploys the EMS for prediction of new data chunks.

Program 150 generates a new base model with new data chunk and adds the generated new base model to the EMS (step 208). Responsive to a detected EMS drift (i.e., model drift), program 150 collects or retrieves a new data chunk partition or dataset. In an embodiment, program 150 triggers an EMS refresh and the generation of a new base model responsive to the detected EMS drift and/or detected data distribution deviation. Program 150 generates a new component model trained with a new data chunk. Responsive to the generation of the new component model, program 150 adds the newly created/trained component model to the EMS.

Program 150 refreshes the EMS (step 210). In an embodiment, program 150 calculates an initial weight for the generated new component model utilizing the evaluation measures described in step 204. For example, program 150 sets an initial weight of a new component model utilizing cross validation with other component models trained with the same partition type, technique, and/or algorithm. Program 150 refreshes the EMS in both model numbers and model weights assigned, thus flexibly and efficiently managing data change over time. In an embodiment, program 150 reevaluates each component model in the EMS. In this embodiment, program 150 recalculates the weights associated with each component model except the newly added component model (i.e., generated model). In this embodiment, program 150 reevaluates each component model utilizing the newly data chunk and associated trained new component model. In an embodiment, program 150 utilizes equation (1) to calculate an AMW for each component model:

AMW=β*AMW+(1−β)*CMW (1)

With respect to equations (1), β is an adjustable parameter, preferably β>=0.9. In another embodiment, program 150 recalculates AMW utilizing an exponentially weighted moving average (EWMA). In an embodiment, program 150 recalculates CMW utilizing evaluation techniques compared against the new data chunk. In an embodiment, program 150 normalizes the adjusted weights and reorders the component models based on associated normalized weight. As detailed in step 204, program 150 reorders the component models in terms of decreasing weight such that the weight of Mᵢ is greater than or equal to the weight of Mᵢ₊₁ for all component models. In an embodiment, program 150 reevaluates each component model utilizing the corresponding evaluation method utilized in the initial calculated weight. For example, program 150 computed an associated weight (i.e., CMW or AMW) of a specific component model utilizing cross validation, thus the recomputed weight should be also computed utilizing cross validation against the new data chunk/partition.

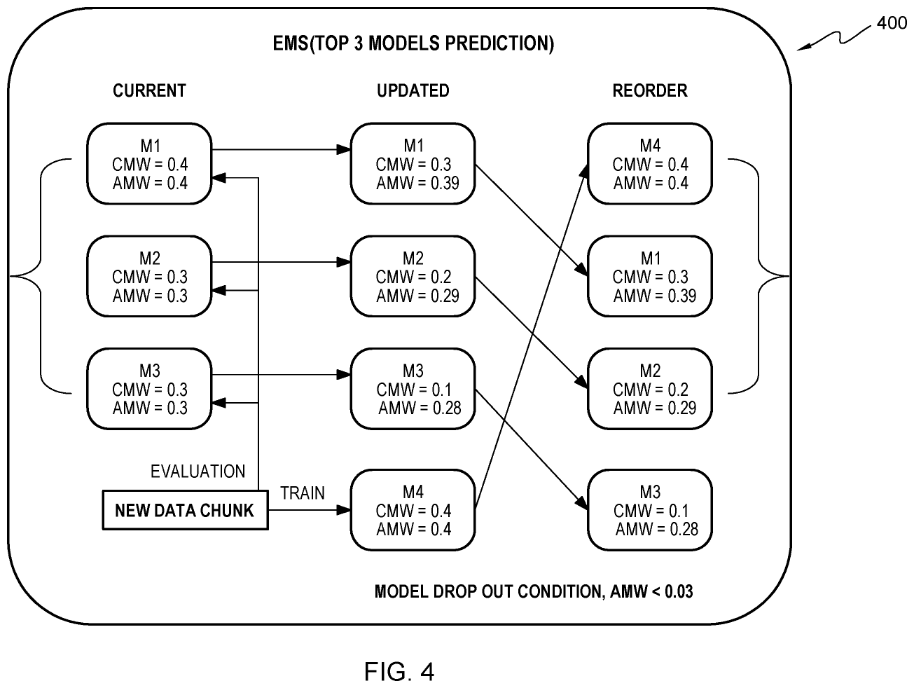

Responsive to program 150 reordering the comprised component models, program 150 removes all models that are less than a dropout threshold. In an embodiment, the dropout threshold is predetermined or set by a user. In another embodiment, program 150 sets and dynamically adjusts the dropout threshold based on computational restrictions associated with the EMS such as limitations on the number of component models or limitations on model storage. For example, program 150 increases the dropout threshold to remove a greater number of component models based on insufficient storage of a computational environment. In this example, program 150 increases a dropout threshold of 0.03 to 0.10 to increase the number of removed models, thus reducing the size of the EMS and associated computational requirements. FIG. 4 further depicts the updating and removal process described above.

Program 150 deploys the EMS for prediction of new data the EMS (step 212). In another embodiment, as program 150 updates one or more associated weights for each component model, program 150 selects a set of top (e.g., top 3) component models to contribute to final prediction between each adjacent model drift without shutting down, suspending, interrupting, and/or restarting the deployed continuous learning system. In this embodiment, program 150 utilizes one or more AMWs and/or CMWs associated with each selected top component model as a prediction weight, where predictions from component models associated with higher prediction weights (i.e., AMW and/or CMW) are given greater deference when aggregating one or more component model predictions (i.e., EMS final prediction). In various embodiments, program 150 deploys a set of component models as a unified ensemble of models, allowing program 150 to utilize the EMS to input new data chunks and output highly accurate predictions despite the individual weakness of each model in the EMS. In a further embodiment, program 150 utilizes the EMS to classify one or more new data chunks (i.e., not contained in a training dataset or partition). For example, program 150 utilizes EMS to classify one or more datapoints representing potential structural defects associated with a physical structure, where program 150 prioritizes which defects to repair based on an associated classification or prediction. In this example, program 150 initiates a defect repair based on the highest predicted defect (e.g., highest numerical percentage or probability).

FIG. 3 depicts example 300 illustrating operational steps of a program partitioning a plurality of data chunks within the computational environment of FIG. 1, in accordance with an embodiment of the present invention. In example 300, program 150 utilizes a plurality of separation, partition, and/or chunking techniques, procedures, and methods to derive a plurality of training sets, subsets, and/or partitions. In example 300, program 150 partitions a plurality of sequential data chunks utilizing associated time granularity (e.g., temporal qualifications) parameters and features (e.g., year, season, month, week, etc.). In example 300, program 150 partitions a plurality of random data chunks utilizing random keys and pre-configured set sizes. In example 300, program 150 partitions a plurality of data chunks utilizing categorical feature splitting, such as geographical splitting. In example 300, program 150 bins data chunks utilizing continuous feature binning to turn continuous variables into categorical values by grouping said values into a pre-defined number of bins. In example 300, program 150 utilizes the entire training set without partitioning. In example 300, program 150 utilizes the aforementioned partitions and data chunks to create an EMS.

FIG. 4 is a functional block diagram illustrating EMS 400 in the computational environment of FIG. 1, in accordance with an embodiment of the present invention. EMS 400 contains a plurality of labelled component models (e.g., M1, M2, M3), each with an associated calculated CMW and AMW. Program 150 detects an EMS drift (i.e., model drift) and trains a new component model (e.g., M4), as described in step 206. Responsively, program 150 recalculates associated CMWs and AMWs against the new data chunk for each component model within EMS 400 and reorders the component models based on CMW and/or AMW, as described in step 210. Program 150, then, creates a set of selected top component models (e.g., M4, M1, M2) that will each contribute a prediction based on associated CMW and AMW values. Additionally, EMS 400 contains a dropout value of AMW<0.03, where component models with associated AMW below 0.03 are removed from the EMS.

FIG. 5 depicts a block diagram of components of server computer 120 in accordance with an illustrative embodiment of the present invention. It should be appreciated that FIG. 5 provides only an illustration of one implementation and does not imply any limitations with regard to the environments in which different embodiments may be implemented. Many modifications to the depicted environment may be made.

Server computer 120 each include communications fabric 504, which provides communications between cache 503, memory 502, persistent storage 505, communications unit 507, and input/output (I/O) interface(s) 506. Communications fabric 504 can be implemented with any architecture designed for passing data and/or control information between processors (such as microprocessors, communications, and network processors, etc.), system memory, peripheral devices, and any other hardware components within a system. For example, communications fabric 504 can be implemented with one or more buses or a crossbar switch.

Memory 502 and persistent storage 505 are computer readable storage media. In this embodiment, memory 502 includes random access memory (RAM). In general, memory 502 can include any suitable volatile or non-volatile computer readable storage media. Cache 503 is a fast memory that enhances the performance of computer processor(s) 501 by holding recently accessed data, and data near accessed data, from memory 502.

Program 150 may be stored in persistent storage 505 and in memory 502 for execution by one or more of the respective computer processor(s) 501 via cache 503. In an embodiment, persistent storage 505 includes a magnetic hard disk drive. Alternatively, or in addition to a magnetic hard disk drive, persistent storage 505 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 505 may also be removable. For example, a removable hard drive may be used for persistent storage 505. Other examples include optical and magnetic disks, thumb drives, and smart cards that are inserted into a drive for transfer onto another computer readable storage medium that is also part of persistent storage 505. Software and data 512 can be stored in persistent storage 505 for access and/or execution by one or more of the respective processors 501 via cache 503.

Communications unit 507, in these examples, provides for communications with other data processing systems or devices. In these examples, communications unit 507 includes one or more network interface cards. Communications unit 507 may provide communications through the use of either or both physical and wireless communications links. Program 150 may be downloaded to persistent storage 505 through communications unit 507.

I/O interface(s) 506 allows for input and output of data with other devices that may be connected to server computer 120. For example, I/O interface(s) 506 may provide a connection to external device(s) 508, such as a keyboard, a keypad, a touch screen, and/or some other suitable input device. External devices 508 can also include portable computer readable storage media such as, for example, thumb drives, portable optical or magnetic disks, and memory cards. Software and data used to practice embodiments of the present invention, e.g., program 150, can be stored on such portable computer readable storage media and can be loaded onto persistent storage 505 via I/O interface(s) 506. I/O interface(s) 506 also connect to a display 509.

Display 509 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, conventional procedural programming languages, such as the “C” programming language or similar programming languages, and quantum programming languages such as the “Q” programming language, Q #, quantum computation language (QCL) or similar programming languages, low-level programming languages, such as the assembly language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures (i.e., FIG) illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
creating, by one or more computer processors, an ensemble model set (EMS) comprising one or more component models, wherein each component model in the EMS is trained utilizing at least one of the following: a distinct algorithm, technique, and hybrid data chunk;
calculating, by one or more computer processors, a set of weights for each component model in the EMS, wherein each set of weights comprises a current model weight (CMW) and an accumulated model weight (AMW);
responsive to detecting model drift, creating, by one or more computer processors, a new component model based on a new hybrid data chunk and adding the new component model to the EMS;
recalculating, by one or more computer processors, the set of weights for each component model in the EMS utilizing one or more evaluation techniques compared against the new hybrid data chunk; and
predicting, by one or more computer processors, a final prediction by aggregating one or more predictions from one or more component models in a set of selected top component models between subsequent model drifts, wherein the predictions from each component model in the set of selected top component models associated with higher weights are given greater deference when aggregating the predictions.

2. The method of claim 1, further comprising:
creating, by one or more computer processors, one or more hybrid data chunks utilizing time granularity, random keys with pre-configured set sizes, categorical feature splitting, and continuous feature binning.

3. The method of claim 1, wherein recalculating the set of weights associated with each component model in the EMS, except the added new component model, utilizing one or more evaluation techniques compared against the new hybrid data chunk, further comprises:
recalculating, by one or more computer processors, the CMW associated with each component model in the EMS utilizing one or more model assessments, evaluation measures, and metrics including k-fold cross validation, mean bias error, modified Nash-Sutcliffe efficiency, root mean square error, or correlation coefficient; and
recalculating, by one or more computer processors, the AMW associated with each component model in the EMS utilizing an exponentially weighted moving average.

4. The method of claim 1, further comprising:
removing, by one or more computer processors, all component models with an associated AMW less than a dropout threshold.

5. The method of claim 4, further comprising:
dynamically adjusting, by one or more computer processors, the dropout threshold based on one or more computational restrictions.

6. The method of claim 1, further comprising:
detecting, by one or more computer processors, a data distribution deviation.

7. The method of claim 1, further comprising:
reordering, by one or more computer processors, the component models contained in the EMS based on associated AMW.

8. A computer program product comprising:
one or more computer readable storage media and program instructions stored on the one or more computer readable storage media, the stored program instructions comprising:
program instructions to create an ensemble model set (EMS) comprising one or more component models, wherein each component model in the EMS is trained utilizing at least one of the following: a distinct algorithm, technique, and hybrid data chunk;
program instructions to calculate a set of weights for each component model in the EMS, wherein each set of weights comprises a current model weight (CMW) and an accumulated model weight (AMW);
program instructions to responsive to detecting model drift, create a new component model based on a new hybrid data chunk and adding the new component model to the EMS;
program instructions to recalculate the set of weights for each component model in the EMS utilizing one or more evaluation techniques compared against the new hybrid data chunk; and
program instructions to predict a final prediction by aggregating one or more predictions from one or more component models in a set of selected top component models between subsequent model drifts, wherein the predictions from each component model in the set of selected top component models associated with higher weights are given greater deference when aggregating the predictions.

9. The computer program product of claim 8, wherein the program instructions, stored on the one or more computer readable storage media, further comprise:
program instructions to create one or more hybrid data chunks utilizing time granularity, random keys with pre-configured set sizes, categorical feature splitting, and continuous feature binning.

10. The computer program product of claim 8, wherein the program instructions to recalculating the set of weights associated with each component model in the EMS, except the added new component model, utilizing one or more evaluation techniques compared against the new hybrid data chunk, further comprise:
program instructions to recalculate the CMW associated with each component model in the EMS utilizing one or more model assessments, evaluation measures, and metrics including k-fold cross validation, mean bias error, modified Nash-Sutcliffe efficiency, root mean square error, or correlation coefficient; and
program instructions to recalculate the AMW associated with each component model in the EMS utilizing an exponentially weighted moving average.

11. The computer program product of claim 8, wherein the program instructions, stored on the one or more computer readable storage media, further comprise:
program instructions to remove all component models with an associated AMW less than a dropout threshold.

12. The computer program product of claim 11, wherein the program instructions, stored on the one or more computer readable storage media, further comprise:
program instructions to dynamically adjust the dropout threshold based on one or more computational restrictions.

13. The computer program product of claim 8, wherein the program instructions, stored on the one or more computer readable storage media, further comprise:
program instructions to detect a data distribution deviation.

14. The computer program product of claim 8, wherein the program instructions, stored on the one or more computer readable storage media, further comprise:
program instructions to reorder the component models contained in the EMS based on associated AMW.

15. A computer system comprising:
one or more computer processors;
one or more computer readable storage media; and
program instructions stored on the computer readable storage media for execution by at least one of the one or more processors, the stored program instructions comprising:
program instructions to create an ensemble model set (EMS) comprising one or more component models, wherein each component model in the EMS is trained utilizing at least one of the following: a distinct algorithm, technique, and hybrid data chunk;
program instructions to calculate a set of weights for each component model in the EMS, wherein each set of weights comprises a current model weight (CMW) and an accumulated model weight (AMW);
program instructions to responsive to detecting model drift, create a new component model based on a new hybrid data chunk and adding the new component model to the EMS;
program instructions to recalculate the set of weights for each component model in the EMS utilizing one or more evaluation techniques compared against the new hybrid data chunk; and
program instructions to predict a final prediction by aggregating one or more predictions from one or more component models in a set of selected top component models between subsequent model drifts, wherein the predictions from each component model in the set of selected top component models associated with higher weights are given greater deference when aggregating the predictions.

16. The computer system of claim 15, wherein the program instructions, stored on the one or more computer readable storage media, further comprise:
program instructions to create one or more hybrid data chunks utilizing time granularity, random keys with pre-configured set sizes, categorical feature splitting, and continuous feature binning.

17. The computer system of claim 15, wherein the program instructions to recalculating the set of weights associated with each component model in the EMS, except the added new component model, utilizing one or more evaluation techniques compared against the new hybrid data chunk, further comprise:
program instructions to recalculate the CMW associated with each component model in the EMS utilizing one or more model assessments, evaluation measures, and metrics including k-fold cross validation, mean bias error, modified Nash-Sutcliffe efficiency, root mean square error, or correlation coefficient; and
program instructions to recalculate the AMW associated with each component model in the EMS utilizing an exponentially weighted moving average.

18. The computer system of claim 15, wherein the program instructions, stored on the one or more computer readable storage media, further comprise:
program instructions to remove all component models with an associated AMW less than a dropout threshold.

19. The computer system of claim 18, wherein the program instructions, stored on the one or more computer readable storage media, further comprise:
program instructions to dynamically adjust the dropout threshold based on one or more computational restrictions.

20. The computer system of claim 15, wherein the program instructions, stored on the one or more computer readable storage media, further comprise:
program instructions to detect a data distribution deviation.
